(19) United States
(12) Patent Application Publication
(10) Pub. No.: US 2025/0326672 A1
(43) Pub. Date: Oct. 23, 2025

(54) ON-SITE WATER SAMPLING AND TREATMENT

(71) Applicant: Saudi Arabian Oil Company, Dhahran (SA)

(72) Inventors: Sattam S. Mutairi, Khobar (SA); Feng Hu Lu, Dhahran (SA); Salman Mohammed Qathami, Dammam (SA); Ahmad A. Mashama, Dhahran (SA)

(21) Appl. No.: 18/643,432

(22) Filed: Apr. 23, 2024

(51) Int. Cl. C02F 9/20; C02F 1/28

(52) U.S. Cl. CPC C02F 9/20; C02F 1/283

(57) ABSTRACT

A portable fluid treatment assembly includes a portable case and a multi-stage sample treatment assembly. The portable case includes a fluid inlet. The multi-stage sample treatment assembly is disposed at least partially inside the portable case and includes a first filter, a piston, a second filter, and a sample container. The first filter includes a chamber defining an inner volume and a partition with a filter surface that divides the inner volume into a first volume and a second volume. The piston is disposed within the first volume and pushes, under an external force applied to the piston, the fluid sample from the first volume, through the filter surface, to the second volume to filter the fluid sample. The second filter receives and further filters the fluid sample from the first filter. The sample container receives and stores the fluid sample from the second filter.

### TECHNICAL FIELD

This disclosure relates water sampling systems.

### BACKGROUND

Water sampling in the oil and gas industry has a wide range of applications, including identifying the origin of produced water, characterizing aquifer properties, interpreting wireline-log measurements, predicting formation damage from water incompatibility, etc. In some cases, water is tested in a laboratory remote from the location of the water. Methods and equipment for sampling and treating water samples are sought.

### SUMMARY

Implementations of the present disclosure include a portable fluid treatment assembly that includes a portable case and a multi-stage sample treatment assembly. The portable case includes a fluid inlet attached to a wall of the portable case and arranged to receive a fluid sample. The multi-stage sample treatment assembly is disposed at least partially inside the portable case. The multi-stage sample treatment assembly includes a first filter, a piston, a second filter, and a sample container. The first filter is disposed within the portable case and fluidly coupled to the fluid inlet. The first filter includes a chamber defining an inner volume and a partition disposed within the chamber. The partition divides the inner volume into a first volume and a second volume. The partition includes a filter surface arranged to filter the fluid sample. The piston is disposed within the first volume and is arranged to push, under an external force applied to the piston from outside the first filter, the fluid sample from the first volume, through the filter surface, to the second volume to filter the fluid sample. The second filter is fluidly coupled to the first filter. The second filter is arranged to receive and further filter the fluid sample from the first filter. The sample container is fluidly coupled to and arranged to receive and store the fluid sample from the second filter. The fluid sample being clean for subsequent ion detection and other testing in the fluid sample.

In some implementations, the multi-stage sample treatment assembly further includes a third filter fluidly coupled to and disposed between the second filter and the sample container. The third filter is arranged to further filter the fluid sample received from the second filter before the fluid sample reaches the sample container.

In some implementations, the portable case includes a second fluid inlet attached to the wall of the portable case and is arranged to receive a raw fluid sample. The multi-stage sample treatment assembly further includes a raw sample container disposed within the portable case and configured to receive and store the raw fluid sample from the second fluid inlet.

In some implementations, the multi-stage sample treatment assembly further includes a fluid pump coupled to and disposed between the first filter and the second filter. The fluid pump is arranged to flow the fluid sample from the first filter to the second filter.

In some implementations, the multi-stage sample treatment assembly further includes a pressure switch disposed between the first filter and the fluid pump and configured to control a pressure of the fluid sample before the fluid sample reaches the fluid pump, an on-off switch electrically coupled to the fluid pump and configured to activate or deactivate the fluid pump, a first flow meter sensor coupled to a first inlet of the sample container, a second flow meter sensor coupled to a second inlet of the raw sample container, and a flow meter coupled to the portable case. The flow meter determines, as a function of feedback received from the first and second flow meter sensors, a flow rate at the first and second inlets.

In some implementations, the fluid sample includes a water sample. The first filter is configured to remove at least one of hydrocarbons or chemicals from the water sample. The second filter is configured to remove at least one of hydrocarbons, chemicals, or solids from the water sample, and the third filter includes granular activated carbon configured to remove at least one of colors, organic matter, or odors from the water sample.

In some implementations, the second filter includes a second chamber defining a second inner volume and a second piston disposed within the second inner volume and arranged to push, under an external force applied to the piston from outside the second filter, the fluid sample along a length of the second filter to further filter the fluid sample.

In some implementations, the portable case includes a base arranged parallel to a horizontal surface supporting the portable case standing upright on the horizontal surface. The first and second filters are arranged such that, with the portable case standing upright on the horizontal surface, the first and second filters are arranged with their respective lengths extending normal with respect to the horizontal surface, allowing the fluid sample to flow, under gravitational force, downward along the respective lengths of the first and second filters.

In some implementations, the portable case further includes a lid arranged to pivot about a hinge to open the portable case and expose the inner volume of the portable case. The lid including foldable legs configured to extend to support the lid in an open position, and a thermally insulated storage compartment arranged to store a plurality of sample containers.

In some implementations, the piston is attached to a rod including a handle at a distal end of the rod opposite the piston. The rod extends through the portable case to expose the handle and allow a force to be applied on the handle from outside the portable case to push the piston.

In some implementations, the portable fluid treatment assembly further includes a low-pressure fluid inlet attached to an upper surface of the portable case and fluidly coupled to the first filter. The first filter receives a second fluid sample through the low pressure fluid inlet. The second fluid sample is at a pressure less than a pressure of the fluid sample.

Implementations of the present disclosure include a fluid treatment assembly that includes a case, a first filter, a piston, a second filter, and a sample container. The case includes a fluid inlet arranged to receive a fluid sample. The first filter is disposed within the case and fluidly coupled to the fluid inlet. The first filter includes a chamber defining an inner volume configured to receive the fluid sample from the fluid inlet. The piston is disposed within the inner volume and arranged to push the fluid sample along the chamber to filter the fluid sample. The second filter is fluidly coupled to the first filter. The second filter is arranged to receive and further filter the fluid sample from the first filter. The sample container is fluidly coupled to and configured to receive and store the fluid sample from the second filter.

In some implementations, the first filter includes a partition including a filter surface configured to filter the fluid sample. The partition divides the inner volume into a first volume that receives the fluid sample from the fluid inlet, and a second volume that received the fluid sample filtered through the filter surface.

In some implementations, the piston resides within the first volume and is attached to a rod attached to a handle disposed at a distal end of the rod opposite the piston. The rod extends through the case to expose the handle and allow a force to be applied on the handle from outside the case to push, with the piston, the fluid sample from the first volume, through the filter surface, to the second volume.

In some implementations, the fluid treatment assembly further includes a third filter fluidly coupled to and disposed between the second filter and the sample container. The third filter is arranged to further filter the fluid sample received from the second filter before the fluid sample reaches the sample container.

In some implementations, the case includes a second fluid inlet attached to the wall of the case and is arranged to receive a raw fluid sample. The fluid treatment assembly further includes a raw sample container disposed within the case and configured to receive and store the raw fluid sample from the second fluid inlet.

In some implementations, the fluid treatment assembly further includes a fluid pump coupled to and disposed between the first filter and the second filter. The fluid pump is arranged to flow the fluid sample from the first filter to the second filter. A fluid inlet of the second filter is disposed, with the case standing on a horizontal surface, at an elevation higher than a fluid outlet of the first filter.

In some implementations, the multi-stage sample treatment assembly further includes a pressure switch, a manual on-off switch, a first flow meter, a second flow meter sensor, and a flow meter. The pressure switch is disposed between the first filter and the fluid pump and is configured to control a pressure of the fluid sample before the fluid sample reaches the fluid pump. The manual on-off switch is electrically coupled to the fluid pump and is configured to activate or deactivate the fluid pump. The first flow meter sensor is coupled to a first inlet of the sample container. The second flow meter sensor is coupled to a second inlet of the raw sample container. The flow meter is coupled to the case and configured to determine, as a function of feedback received from the first and second flow meter sensors, a flow rate at the first and second inlets of the sample containers.

In some implementations, the case includes a portable case with a lid arranged to pivot about a hinge to open the portable case and expose the inner volume of the portable case. The lid includes foldable legs, a storage compartment, and a thermally insulated storage compartment. The foldable legs extend to support the lid in an open position. The storage compartment stores a plurality of replacement parts. The thermally insulated storage compartment is arranged to store a plurality of sample containers.

Implementations of the present disclosure includes a fluid treatment method that includes directing a fluid sample into a first filter disposed within a portable case. The first filter includes a chamber defining an inner volume configured to receive the fluid sample. The method also includes pushing, with a piston disposed within the inner volume, the fluid sample along the chamber to filter the fluid sample. The method also includes directing the fluid sample from the first filter to a second filter fluidly coupled to the first filter to further filter the fluid sample. The method also includes directing the fluid sample from the second filter to a sample container fluidly coupled to and configured to receive and store the fluid sample from the second filter.

Particular implementations of the subject matter described in this specification can be implemented so as to realize one or more of the following advantages. For example, the on-site water sampling and treatment system of the present disclosure allows water samples to be safely stored on site and kept from becoming contaminated before the sample is tested in a laboratory. Additionally, the on-site water sampling and treatment system of the preset disclosure allows the system to be quickly transported on a strong, movable case that protects the water samples and allows fast, safe, and reliable transportation of the water samples. Moreover, the on-site water sampling and treatment system allows water to maintain its original ions, which allows accurate testing of the water sample at a remote laboratory. Additionally, the on-site water sampling and treatment system allows for the standardization of sampling procedures.

### BRIEF DESCRIPTION OF THE DRAWINGS

FIG. 1 shows a front schematic view, partially cross-sectional, of an on-site water sampling and treatment system.

FIG. 2 shows a front schematic view, partially cross-sectional, of a lid of the on-site water sampling and treatment system.

FIG. 3 shows a perspective schematic view of the on-site water sampling and treatment system, with its lid closed.

FIG. 4 shows a perspective schematic view of the on-site water sampling and treatment system, with its lid open.

FIG. 5 shows a front schematic view of the on-site water sampling and treatment system.

FIG. 6 shows a back schematic view of the on-site water sampling and treatment system.

FIG. 7 show a flow chart of an example method of sampling and treating a fluid sample.

### DETAILED DESCRIPTION OF THE DISCLOSURE

The on-site water sampling and treatment system of the present disclosure allows for water samples to be stored on-site for later testing at a laboratory. The on-site water sampling and treatment system prevents contamination of the water sample during storage and transportation of the water sample. The on-site water sampling and treatment system limits all or multiple causes of onsite water sampling contaminations, protects water samples from harsh weather conditions, and treats the water samples by multistage filtration processes to ensure removal of hydrocarbon, solids, and chemical additives. The on-site water sampling and treatment system can be used to test fluids on-site at oil and gas wells and rigs, as well as to test bodies of water (e.g., ponds, seawaters, rivers, lakes) for the surface.

Because the water samples contain formation hydrocarbons, well chemical, additives, and solids, if the water sample is stored with such contaminants for long periods of time, such contaminants can dissolve and disassociate in the water. This can change the overall ions and chemistry of the water and can mask the true signals of the original ions in collected water samples. The on-site water sampling and treatment system of the present disclosure removes the water contaminants before and maintains the water samples clean until the water samples reach the laboratory. Thus, the on-site water sampling and treatment system of the present disclosure samples water and trats the samples onsite. Treatment of the samples onsite help save time and resources as compared to treating the samples in a laboratory.

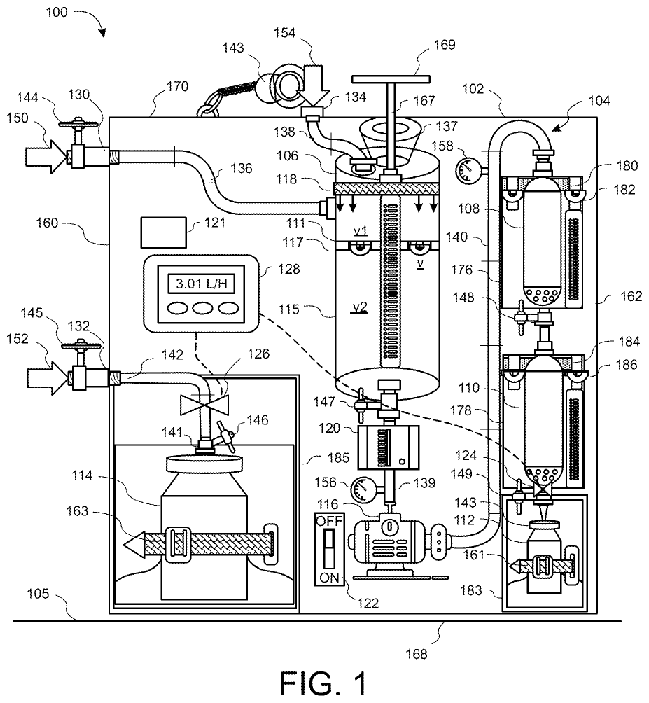

FIG. 1 shows a portable fluid treatment assembly 100 (e.g., an on-site water sampling and treatment system) that includes a portable case 102 and a multi-stage sample treatment assembly 104 that resides at least partially inside the portable case 102. For simplicity, the portable case 102 is shown without its wheels, handle, and other components of the case.

In some aspects, the portable case 102 is shaped as a hard shell protector case and is made of hard plastic, metal, a composite, or a similar material. The portable case 102 can be transported by one person to oil and gas wells and rigs or to other sites such as remote bodies of water. The portable case 102 can be water-tight when closed and has a hard shell to protect the multi-stage sample treatment assembly 104 from the environment.

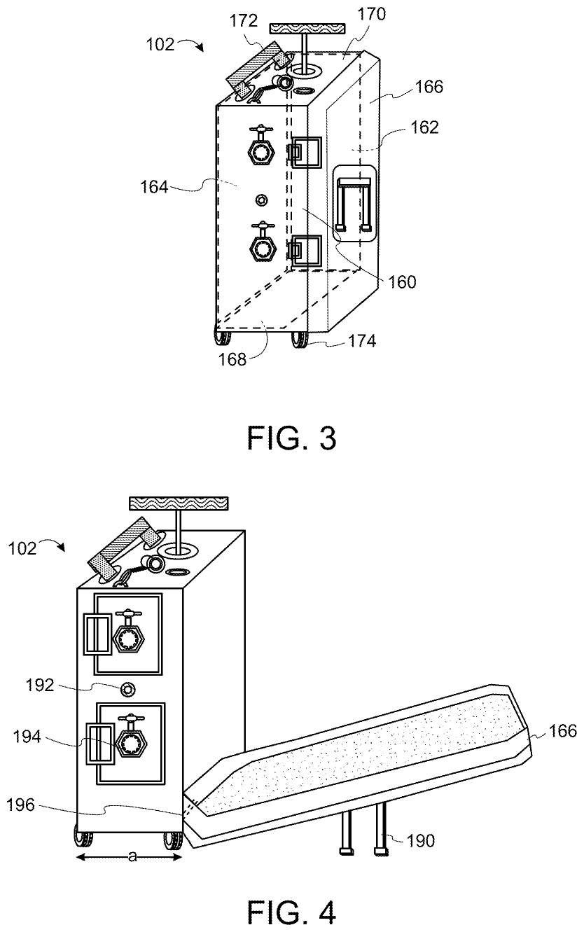

As shown in FIG. 3, the portable case 102 has two side walls 160, 162, a back wall 164, a lid 166, a base a base 168, and a top 170. The portable case 102 has a handle 172 (e.g., a telescopic or retractable handle) attached to the top 170 and four roller wheels 174 attached to the base 168. The portable case 102 can be carried or rolled on its wheels 174 like a suitcase. For example, the roller wheels 174 allow the portable case 102 to be moved by one person pulling on the handle with the case 102 remaining upright (rolled on all four wheels 174) or tilted (rolled on two of the four wheels 174).

Referring back to FIG. 1, the portable case 102 has multiple fluid inlets 130, 132, 134 connected to various components of the multi-stage sample treatment assembly 104. The fluid inlets include a first fluid inlet 130 and a second fluid inlet 132 attached to the first side wall 160 of the portable case 102. The third fluid inlet 134 is attached to the top 170 of the portable case 102. The first fluid inlet 130 receives a first fluid 150 (e.g., a first pressurized water sample), the second fluid inlet 132 receives a second fluid 152 (e.g., a second pressurized water sample), and the third fluid inlet 134 receives a third fluid 154 (e.g., a low-pressure water sample).

The multi-stage sample treatment assembly 104 includes a first filter 106 (e.g., a sample treatment filter), a second filter 108 (e.g., a micro-solid removal filter), a third filter 110 (e.g., a granular activated carbon filter), a first sample container 112 (e.g., a filtered sample container), a second sample container 114 (e.g., a raw sample container), and a fluid pump 116 (e.g., a reverse osmosis water pump).

The multi-stage sample treatment assembly 104 also includes a piston 118 (e.g., a plastic desk-like plunger), a pressure switch 120 (e.g., small pressure switch manifold), an on-off switch 122, a first flow meter sensor 124, a second flow meter sensor 126, and a flow meter 128. The portable fluid treatment assembly 100 also includes multiple fluid lines 136, 138, 140, 142 (e.g., 1.2-millimeter hoses), multiple valves 144, 145, 146, 147, 148, 149, multiple pressure gauges (or types of pressure sensors) 156, 158, and multiple compartments 183, 185.

For example, the portable fluid treatment assembly 100 includes a shut in valve 144, 145 at each of the first and second fluid inlets 130, 132, a plug 143 for manually closing the third fluid inlet 134, a valve 146 at an inlet 141 of the second container 114, a valve 147 at the outlet of the first filter 106, a valve 148 at the outlet of the second filter 108, and a valve 149 at the outlet of the third filter 110. The valves 147, 148, 149 regulate the flow of the fluid sample leaving the first filter 106, second filter 108, and third filter 110 respectively. The valve 146 at the inlet 141 of the second sample container 114 regulates the flow of fluid of the second fluid sample 152 into the second sample container 114.

The pressure gauges 156, 158 detect the pressure of the fluid sample 150 along fluid lines 139, 140 respectively. In some aspects, the pressure gauges 156, 158 are electrically coupled to a controller 121 that controls, as a function of sensor feedback received from the pressure gauges 156, 158, the valves 147, 148, 149 to change the pressure of the fluid sample 150.

In some aspects, the multiple compartments 183, 185 house the sample containers 112, 114 during the sampling and/or filtering of the fluid samples 150, 152. Each compartment 183, 185 can be padded to snuggly secure each sample container 112, 114. Each compartment 183, 185 has a strap 161, 163 that tightly secures each sample container 112, 114 to the respective compartment 183, 185. Each compartment 183, 185 isolates its respective container 112, 114 from fluids and temperatures within the rest of the case 102.

In some aspects, the pressure switch 120 resides between the first filter 106 and the fluid pump 116. The pressure switch can change, along with the valve 147, the pressure of the fluid sample 150 before the fluid sample 150 reaches the pump 116. The manual on-off switch 122 is an electrical switch that a user can operate to activate or deactivate the fluid pump 116.

The first flow meter sensor 124 is coupled to or near the inlet of the first sample container 112 and the second flow meter sensor 126 is coupled to the inlet 141 of the raw sample container 114. The flow meter sensors 124, 126 are electrically connected to the flow meter 128. The flow meter sensors 124, 126 transmit signals to the flow meter 128, from which the flow meter 128 determines the flow rate of the fluid samples 150, 152. Specifically, the flow meter 128 determines, as a function of feedback received from the first and second flow meter sensors 124, 126, a flow rate at the first and second inlets of the sample containers. The flow meter 128 has an electronic display that displays the flow rate of the first and second fluid samples 150, 152. A user can control the flow rate and pressure of the fluid samples 150, 152 based on the flow rate displayed by the flow meter 128.

In some aspects, the controller 121 controls at least some of the valves 144, 145, 146, 147, 148, 149 as a function of the feedback from the sensors 124, 126 and the gauges 156, 158. The controller 121 controls the valves to change the flow rate and pressure of the fluid samples 150, 152, 154 as the fluid samples flow through the filters and lines of the multi-stage sample treatment assembly 104.

The first filter 106 has a chamber 115 or barrel that defines an inner volume “V.” The first filter 106 also has a partition 117 (e.g., a filter plate) disposed within the chamber 115. The partition 117 divides the inner volume “V” into a first volume “v1” and a second volume “v2.” The partition 117 has a filter surface 111 (e.g., 2 millimeter or 0.45 micrometer filter) that filters the fluid sample by retaining and removing hydrocarbons or chemicals or both as the fluid passes through the filter surface 111. The partition 117 can be removable so that a user can replace or clean the filter surface 111. For example, the partition 117 can be removed by a simple slide in desk.

In some aspects, the chamber is a 1.5-liter cylindrical sample chamber, with the first volume “v1” being a 0.5-liter volume and the second volume “v2” being a 1-liter volume. The chamber 115 is isolated by O-ring 137 or other sealers to reduce or prevent exposure to the weather or harsh environment conditions.

During this first filtration stage, the first fluid sample 150 (or the third fluid sample 154) is filtered in the first filter 106 to remove hydrocarbons and chemicals that can damage the system. Specifically, the raw fluid sample 150 is manually pushed by the piston 118 through the filter surface 111. The piston 118 is disposed and constrained to movement within the first volume “v1” of the first filter 106. The piston 118 acts as the piston in a manual bicycle pump, in which a user pushes on the piston 118 to push fluid down along the length of a barrel or chamber.

For example, the piston 118 is attached to a rod 167 that is attached to a handle 169 residing at a distal end of the rod 167 opposite the piston 118. The rod 167 extends through the portable case 102 to expose the handle 169 and allow a downward force (e.g., applied by a person pushing down on the handle) to be applied on the handle 169 from outside the portable case 102. Pushing down on the handle 169 pushes the piston 118 down to push the fluid sample 150 from the first volume “v1,” through the filter surface 111, to the second volume “v2” to filter (e.g., preliminarily filter) the fluid sample 150.

Once enough fluid is in the second volume “v2,” the fluid sample in the second volume “v2” drains, by gravitational force, downward out of the first filter 106 and into the pump 116. On its way down, the fluid sample 150 passes through the pressure switch 120, where the pressure is raised or lowered before the fluid sample 150 enters the water pump 116. Once enough of the fluid sample 150 enters the pump 116, the user activates the pump 116 by flipping the switch 122 from the off to the on position.

Then, the water pump 116 pushes the fluid sample 150 through the line 140 into the second filter 108. The second filter 108 and third filter 110 each reside within a respective fluid chamber 176, 178 (e.g., a 0.5-liter container) that receives the fluid sample 150 after the fluid sample 150 has been filtered by (and exits) the respective filter 108, 110. Additionally, each fluid chamber 176, 178 is equipped with a piston 180, 184, and handle 182, 186 that a user can pull or push downward to push the piston 180, 184 and push the fluid sample 150 down into the next stage. Because the fluid inlet of the second filter 108 resides, with the case 102 standing upright on a horizontal surface 105, at an elevation higher than the fluid outlet of the first filter 106, the pump 116 lifts the fluid sample 150 to flow the fluid sample 150 into the second filter 108.

For example, after the pump 116 flows the fluid sample 150 into the second filter 108, the second filter 108 filters out micro solids (and can also remove any remaining hydrocarbons) that are left in the fluid sample 150. The fluid sample 150 then exits the second filter 108 through the bottom apertures of the filter 108 and fills the second chamber 176. The second chamber 176 can have a gradual volume scale to collect the fluid sample 150 after the fluid sample 150 has been filtered. In some aspects, the second filter 108 takes around two minutes to filter out a 0.5-litter portion of the sample. Once the filtered fluid sample 150 fills the second fluid chamber 176, a user manually pushes on the handles 182 to push the piston 180 or small arm that pushes the fluid sample 150 downward and out of the second chamber 176, ensuring all or substantially all of the fluid sample 150 gets drained out. Additionally or alternatively, the fluid sample 150 can flow down and out of the second fluid chamber 17 under gravitational force.

The third filter 110 is fluidly coupled to and resides between the second filter 108 and the sample container 112. The third filter 110 further filters the fluid sample 150 received from the second filter 108 before the fluid sample 150 reaches the sample container 112. The third filter 110 removes the remaining stranded chemicals or hydrocarbons or both. In some aspects, the third filter 110 is filled with granular activated carbon (GAC). Beside hydrocarbon and chemicals, the third filter 110 can remove odors, colors, and organic matter. The third filter is placed inside a 0.5 L container as well. After the fluid sample 150 exits the third filter 110 and fills the third chamber 178, the fluid sample 150 pours out, by valve, into the final sample container 112. Additionally or alternatively, the user manually pushes on the handles 186 to push the piston 184 and push the fluid sample 150 downward, or the fluid sample 150 can flow down and out of the second fluid chamber 17 only under gravitational force.

The fluid sample 150 exits the third chamber 178 clean to be stored in the sample container 112. Once the fluid sample 150 is stored in the sample container 112, a user can remove the sample container 112 from its compartment 183 and store it in the iced compartments in the lid of the portable case 102.

Removing the contaminants from the fluid sample 150 prevents the contaminants from dissolving and masking the true signals of the ions in the fluid sample 150. Thus, the sample container 112 receives the filtered water sample and keeps the water sample 150 clean (or with the same or substantially the same ions as originally received at the inlet 130) so that the true signals of the ions are not masked during testing of the sample 150 in a laboratory. The sample containers 112, 114 can be made of glass, metal, plastic, or a similar material.

The filters 106, 108, 110 are arranged such that, with the portable case standing on the horizontal surface 105, the filters have their respective lengths extending normal or perpendicular with respect to the horizontal surface 105. This allows the fluid sample 150 to flow, under gravitational force, downward along the respective lengths of the filters and out of the filters.

The second fluid container 114 is fluidly coupled to the second fluid inlet 132. The user connects a fluid line that flows a raw fluid sample 152 into the second inlet 132. The second inlet 132 directs the raw fluid sample 152 to the raw sample container 114 to store the raw fluid sample 152. The second fluid sample 152 can be used at the laboratory to compare its properties with the filtered and clean first fluid sample 150.

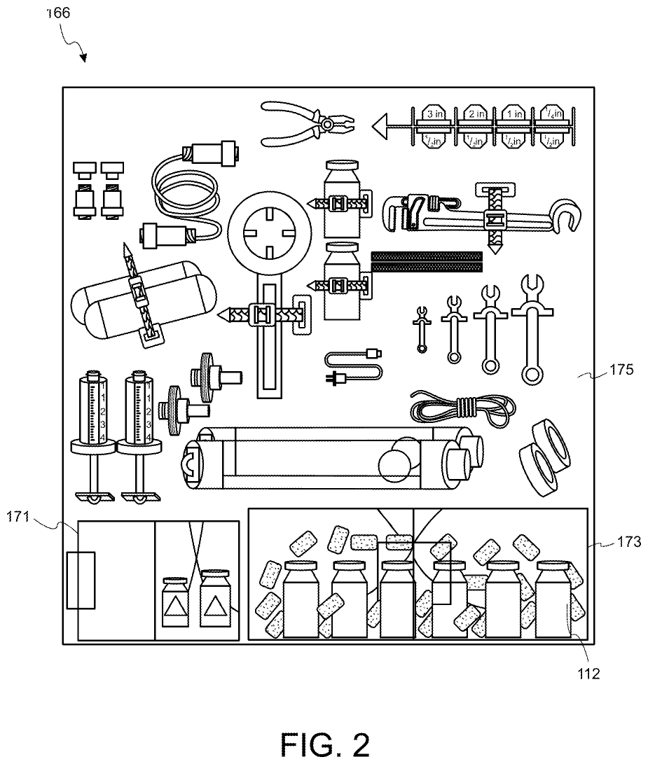

Referring now to FIGS. 2 and 4, the lid 166 of the portable case 102 stores various components and opens about a pivot, similar to a briefcase. For example, as shown in FIG. 4, the lid 166 pivots about one or more hinges 196 to open the portable case 102 and expose the inner volume of the portable case 102. The lid 166 has foldable legs 190 that unfold or otherwise extend to support the lid 166 in an open position. The outside valves and fluid inlets have removable hard plastic caps 194 to protect from falls and dust. In some aspects, the case 102 also has a pressure balance button 192 to balance or release pressure and water/humidity within the case 102 (e.g., in case of air travel).

As shown in FIG. 2, the lid 166 also has a clean sample storage compartment 173 (e.g., a thermally insulated storage compartment), an equipment compartment 175, and a chemical or raw sample compartment 171. The chemical or raw sample compartment 171 can store the sample containers 114 with the raw water samples 152 or chemicals (e.g., solvents) used for some sampling procedures like sulfur species preservation. The clean sample storage compartment 173 can store multiple sample containers 112 and can hold ice or other cold item to keep the sample containers 112 at a desired temperature.

The equipment compartment 175 can store, for example, lure in top plastic syringes with lure in small filters, extra filters, fittings and connections, empty sampling containers, filter fittings, water bailers with robes for water sampling, Teflon tapes, sampling hoses, wrenches, among other equipment and accessories.

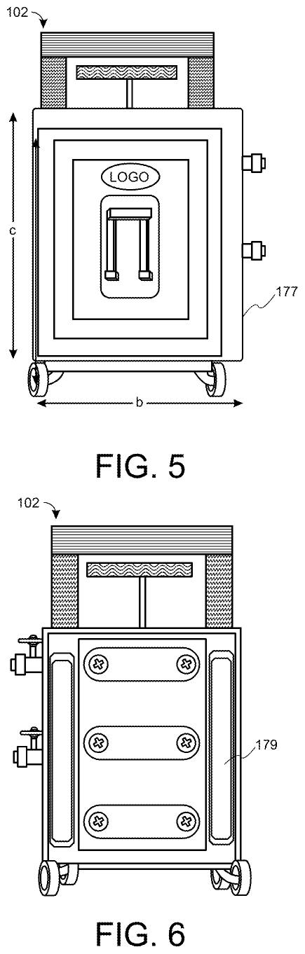

As shown in FIGS. 5 and 6, the portable case 102 is covered by rubber pads 177, 179. The inside of the case can also have one or more layers of foam for corrosion and fall protection. The portable case 102 is thus rugged, waterproof or water resistant, crush resistant, and dustproof. The case 102 has a width “a” (see FIG. 4), length “b,” and height “c.” The width “a” can be, for example, between 15 and 23 inches long (e.g., 19 inches long), the length “b” can be, for example, between 30 and 37 inches long (e.g., 34 inches long), and the height “c” can be, for example, between 40 and 50 inches long (e.g., 45 inches long). The weight of the case can be, for example, between 30 and 45 lbs.

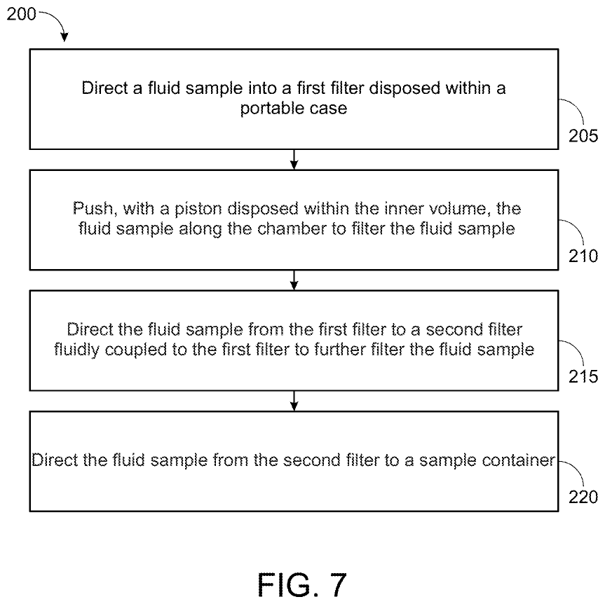

FIG. 7 shows a flow chart of a fluid treatment method (200). The method includes directing a fluid sample into a first filter disposed within a portable case, the first filter comprising a chamber defining an inner volume configured to receive the fluid sample (205). The method also includes pushing, with a piston disposed within the inner volume, the fluid sample along the chamber to filter the fluid sample (210). The method also includes directing the fluid sample from the first filter to a second filter fluidly coupled to the first filter to further filter the fluid sample (215). The method also includes directing the fluid sample from the second filter to a sample container fluidly coupled to and configured to receive and store the fluid sample from the second filter (220).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

### Examples

In an example implementation, a portable fluid treatment assembly includes a portable case and a multi-stage sample treatment assembly. The portable case includes a fluid inlet attached to a wall of the portable case and arranged to receive a fluid sample. The multi-stage sample treatment assembly is disposed at least partially inside the portable case. The multi-stage sample treatment assembly includes a first filter, a piston, a second filter, and a sample container. The first filter is disposed within the portable case and fluidly coupled to the fluid inlet. The first filter includes a chamber defining an inner volume and a partition disposed within the chamber. The partition divides the inner volume into a first volume and a second volume. The partition includes a filter surface arranged to filter the fluid sample. The piston is disposed within the first volume and is arranged to push, under an external force applied to the piston from outside the first filter, the fluid sample from the first volume, through the filter surface, to the second volume to filter the fluid sample. The second filter is fluidly coupled to the first filter. The second filter is arranged to receive and further filter the fluid sample from the first filter. The sample container is fluidly coupled to and arranged to receive and store the fluid sample from the second filter. The fluid sample being clean for subsequent ion detection and other testing in the fluid sample.

In an example implementation combinable with any other example implementation, the multi-stage sample treatment assembly further comprises a third filter fluidly coupled to and disposed between the second filter and the sample container. The third filter is arranged to further filter the fluid sample received from the second filter before the fluid sample reaches the sample container.

In an example implementation combinable with any other example implementation, the portable case comprises a second fluid inlet attached to the wall of the portable case and is arranged to receive a raw fluid sample. The multi-stage sample treatment assembly further comprises a raw sample container disposed within the portable case and configured to receive and store the raw fluid sample from the second fluid inlet.

In an example implementation combinable with any other example implementation, the multi-stage sample treatment assembly further comprises a fluid pump coupled to and disposed between the first filter and the second filter. The fluid pump is arranged to flow the fluid sample from the first filter to the second filter.

In an example implementation combinable with any other example implementation, the multi-stage sample treatment assembly further comprises a pressure switch disposed between the first filter and the fluid pump and configured to control a pressure of the fluid sample before the fluid sample reaches the fluid pump, an on-off switch electrically coupled to the fluid pump and configured to activate or deactivate the fluid pump, a first flow meter sensor coupled to a first inlet of the sample container, a second flow meter sensor coupled to a second inlet of the raw sample container, and a flow meter coupled to the portable case. The flow meter determines, as a function of feedback received from the first and second flow meter sensors, a flow rate at the first and second inlets.

In an example implementation combinable with any other example implementation, the fluid sample comprises a water sample. The first filter is configured to remove at least one of hydrocarbons or chemicals from the water sample. The second filter is configured to remove at least one of hydrocarbons, chemicals, or solids from the water sample, and the third filter comprises granular activated carbon configured to remove at least one of colors, organic matter, or odors from the water sample.

In an example implementation combinable with any other example implementation, the second filter includes a second chamber defining a second inner volume and a second piston disposed within the second inner volume and arranged to push, under an external force applied to the piston from outside the second filter, the fluid sample along a length of the second filter to further filter the fluid sample.

In an example implementation combinable with any other example implementation, the portable case comprises a base arranged parallel to a horizontal surface supporting the portable case standing upright on the horizontal surface. The first and second filters are arranged such that, with the portable case standing upright on the horizontal surface, the first and second filters are arranged with their respective lengths extending normal with respect to the horizontal surface, allowing the fluid sample to flow, under gravitational force, downward along the respective lengths of the first and second filters.

In an example implementation combinable with any other example implementation, the portable case further comprises a lid arranged to pivot about a hinge to open the portable case and expose the inner volume of the portable case. The lid comprising foldable legs configured to extend to support the lid in an open position, and a thermally insulated storage compartment arranged to store a plurality of sample containers.

In an example implementation combinable with any other example implementation, the piston is attached to a rod comprising a handle at a distal end of the rod opposite the piston. The rod extends through the portable case to expose the handle and allow a force to be applied on the handle from outside the portable case to push the piston.

In an example implementation combinable with any other example implementation, the portable fluid treatment assembly further comprises a low-pressure fluid inlet attached to an upper surface of the portable case and fluidly coupled to the first filter. The first filter receives a second fluid sample through the low pressure fluid inlet. The second fluid sample is at a pressure less than a pressure of the fluid sample.

Implementations of the present disclosure include a fluid treatment assembly that includes a case, a first filter, a piston, a second filter, and a sample container. The case comprises a fluid inlet arranged to receive a fluid sample. The first filter is disposed within the case and fluidly coupled to the fluid inlet. The first filter comprises a chamber defining an inner volume configured to receive the fluid sample from the fluid inlet. The piston is disposed within the inner volume and arranged to push the fluid sample along the chamber to filter the fluid sample. The second filter is fluidly coupled to the first filter. The second filter is arranged to receive and further filter the fluid sample from the first filter. The sample container is fluidly coupled to and configured to receive and store the fluid sample from the second filter.

In an example implementation combinable with any other example implementation, the first filter comprises a partition comprising a filter surface configured to filter the fluid sample. The partition divides the inner volume into a first volume that receives the fluid sample from the fluid inlet, and a second volume that received the fluid sample filtered through the filter surface.

In an example implementation combinable with any other example implementation, the piston resides within the first volume and is attached to a rod attached to a handle disposed at a distal end of the rod opposite the piston. The rod extends through the case to expose the handle and allow a force to be applied on the handle from outside the case to push, with the piston, the fluid sample from the first volume, through the filter surface, to the second volume.

In an example implementation combinable with any other example implementation, the fluid treatment assembly further comprises a third filter fluidly coupled to and disposed between the second filter and the sample container. The third filter is arranged to further filter the fluid sample received from the second filter before the fluid sample reaches the sample container.

In an example implementation combinable with any other example implementation, the case comprises a second fluid inlet attached to the wall of the case and is arranged to receive a raw fluid sample. The fluid treatment assembly further comprises a raw sample container disposed within the case and configured to receive and store the raw fluid sample from the second fluid inlet.

In an example implementation combinable with any other example implementation, the fluid treatment assembly further comprises a fluid pump coupled to and disposed between the first filter and the second filter. The fluid pump is arranged to flow the fluid sample from the first filter to the second filter. A fluid inlet of the second filter is disposed, with the case standing on a horizontal surface, at an elevation higher than a fluid outlet of the first filter.

In an example implementation combinable with any other example implementation, the multi-stage sample treatment assembly further includes a pressure switch, a manual on-off switch, a first flow meter, a second flow meter sensor, and a flow meter. The pressure switch is disposed between the first filter and the fluid pump and is configured to control a pressure of the fluid sample before the fluid sample reaches the fluid pump. The manual on-off switch is electrically coupled to the fluid pump and is configured to activate or deactivate the fluid pump. The first flow meter sensor is coupled to a first inlet of the sample container. The second flow meter sensor is coupled to a second inlet of the raw sample container. The flow meter is coupled to the case and configured to determine, as a function of feedback received from the first and second flow meter sensors, a flow rate at the first and second inlets of the sample containers.

In an example implementation combinable with any other example implementation, the case comprises a portable case with a lid arranged to pivot about a hinge to open the portable case and expose the inner volume of the portable case. The lid includes foldable legs, a storage compartment, and a thermally insulated storage compartment. The foldable legs extend to support the lid in an open position. The storage compartment stores a plurality of replacement parts. The thermally insulated storage compartment is arranged to store a plurality of sample containers.

Implementations of the present disclosure includes a fluid treatment method that includes directing a fluid sample into a first filter disposed within a portable case. The first filter comprises a chamber defining an inner volume configured to receive the fluid sample. The method also includes pushing, with a piston disposed within the inner volume, the fluid sample along the chamber to filter the fluid sample. The method also includes directing the fluid sample from the first filter to a second filter fluidly coupled to the first filter to further filter the fluid sample. The method also includes directing the fluid sample from the second filter to a sample container fluidly coupled to and configured to receive and store the fluid sample from the second filter.

What is claimed is:

1. A portable fluid treatment assembly, comprising:
a portable case comprising a fluid inlet attached to a wall of the portable case and arranged to receive a fluid sample; and
a multi-stage sample treatment assembly disposed at least partially inside the portable case, the multi-stage sample treatment assembly comprising:
a first filter disposed within the portable case and fluidly coupled to the fluid inlet, the first filter comprising a chamber defining an inner volume and a partition disposed within the chamber, the partition dividing the inner volume into a first volume and a second volume, the partition comprising a filter surface arranged to filter the fluid sample;
a piston disposed within the first volume and arranged to push, under an external force applied to the piston from outside the first filter, the fluid sample from the first volume, through the filter surface, to the second volume to filter the fluid sample;
a second filter fluidly coupled to the first filter, the second filter arranged to receive and further filter the fluid sample from the first filter; and
a sample container fluidly coupled to and arranged to receive and store the fluid sample from the second filter, the fluid sample being clean for subsequent ion detection in the fluid sample.

2. The portable fluid treatment assembly of claim 1, wherein the multi-stage sample treatment assembly further comprises a third filter fluidly coupled to and disposed between the second filter and the sample container, the third filter arranged to further filter the fluid sample received from the second filter before the fluid sample reaches the sample container.

3. The portable fluid treatment assembly of claim 2, wherein the portable case comprises a second fluid inlet attached to the wall of the portable case and arranged to receive a raw fluid sample, the multi-stage sample treatment assembly further comprising a raw sample container disposed within the portable case and configured to receive and store the raw fluid sample from the second fluid inlet.

4. The portable fluid treatment assembly of claim 3, wherein the multi-stage sample treatment assembly further comprises a fluid pump coupled to and disposed between the first filter and the second filter, the fluid pump arranged to flow the fluid sample from the first filter to the second filter.

5. The portable fluid treatment assembly of claim 4, wherein the multi-stage sample treatment assembly further comprises a pressure switch disposed between the first filter and the fluid pump and configured to control a pressure of the fluid sample before the fluid sample reaches the fluid pump, an on-off switch electrically coupled to the fluid pump and configured to activate or deactivate the fluid pump, a first flow meter sensor coupled to a first inlet of the sample container, a second flow meter sensor coupled to a second inlet of the raw sample container, and a flow meter coupled to the portable case and configured to determine, as a function of feedback received from the first and second flow meter sensors, a flow rate at the first and second inlets.

6. The portable fluid treatment assembly of claim 2, wherein the fluid sample comprises a water sample, the first filter is configured to remove at least one of hydrocarbons or chemicals from the water sample, the second filter is configured to remove at least one of hydrocarbons, chemicals, or solids from the water sample, and the third filter comprises granular activated carbon configured to remove at least one of colors, organic matter, or odors from the water sample.

7. The portable fluid treatment assembly of claim 1, wherein the second filter comprises a second chamber defining a second inner volume and a second piston disposed within the second inner volume and arranged to push, under an external force applied to the piston from outside the second filter, the fluid sample along a length of the second filter to further filter the fluid sample.

8. The portable fluid treatment assembly of claim 1, wherein the portable case comprises a base arranged parallel to a horizontal surface supporting the portable case standing upright on the horizontal surface, and the first and second filters are arranged such that, with the portable case standing upright on the horizontal surface, the first and second filters are arranged with their respective lengths extending normal with respect to the horizontal surface, allowing the fluid sample to flow, under gravitational force, downward along the respective lengths of the first and second filters.

9. The portable fluid treatment assembly of claim 8, wherein the portable case further comprises a lid arranged to pivot about a hinge to open the portable case and expose the inner volume of the portable case, the lid comprising foldable legs configured to extend to support the lid in an open position, and a thermally insulated storage compartment arranged to store a plurality of sample containers.

10. The portable fluid treatment assembly of claim 1, wherein the piston is attached to a rod comprising a handle at a distal end of the rod opposite the piston, the rod extending through the portable case to expose the handle and allow a force to be applied on the handle from outside the portable case to push the piston.

11. The portable fluid treatment assembly of claim 1, further comprising a low-pressure fluid inlet attached to an upper surface of the portable case and fluidly coupled to the first filter, the first filter configured to receive a second fluid sample through the low pressure fluid inlet, the second fluid sample at a pressure less than a pressure of the fluid sample.

12. A fluid treatment assembly, comprising:
a case comprising a fluid inlet arranged to receive a fluid sample;
a first filter disposed within the case and fluidly coupled to the fluid inlet, the first filter comprising a chamber defining an inner volume configured to receive the fluid sample from the fluid inlet;
a piston disposed within the inner volume and arranged to push the fluid sample along the chamber to filter the fluid sample;
a second filter fluidly coupled to the first filter, the second filter arranged to receive and further filter the fluid sample from the first filter; and
a sample container fluidly coupled to and configured to receive and store the fluid sample from the second filter.

13. The fluid treatment assembly of claim 12, wherein the first filter comprises a partition comprising a filter surface configured to filter the fluid sample, the partition dividing the inner volume into a first volume that receives the fluid sample from the fluid inlet, and a second volume that received the fluid sample filtered through the filter surface.

14. The fluid treatment assembly of claim 13, wherein the piston resides within the first volume and is attached to a rod attached to a handle disposed at a distal end of the rod opposite the piston, the rod extending through the case to expose the handle and allow a force to be applied on the handle from outside the case to push, with the piston, the fluid sample from the first volume, through the filter surface, to the second volume.

15. The fluid treatment assembly of claim 13, further comprising a third filter fluidly coupled to and disposed between the second filter and the sample container, the third filter arranged to further filter the fluid sample received from the second filter before the fluid sample reaches the sample container.

16. The fluid treatment assembly of claim 15, wherein the case comprises a second fluid inlet attached to the wall of the case and arranged to receive a raw fluid sample, the fluid treatment assembly further comprising a raw sample container disposed within the case and configured to receive and store the raw fluid sample from the second fluid inlet.

17. The fluid treatment assembly of claim 16, wherein the fluid treatment assembly further comprises a fluid pump coupled to and disposed between the first filter and the second filter, the fluid pump arranged to flow the fluid sample from the first filter to the second filter, with a fluid inlet of the second filter disposed, with the case standing on a horizontal surface, at an elevation higher than a fluid outlet of the first filter.

18. The fluid treatment assembly of claim 17, wherein the multi-stage sample treatment assembly further comprises a pressure switch disposed between the first filter and the fluid pump and configured to control a pressure of the fluid sample before the fluid sample reaches the fluid pump, a manual on-off switch electrically coupled to the fluid pump and configured to activate or deactivate the fluid pump, a first flow meter sensor coupled to a first inlet of the sample container, a second flow meter sensor coupled to a second inlet of the raw sample container, and a flow meter coupled to the case and configured to determine, as a function of feedback received from the first and second flow meter sensors, a flow rate at the first and second inlets of the sample containers.

19. The fluid treatment assembly of claim 13, wherein the case comprises a portable case further comprises a lid arranged to pivot about a hinge to open the portable case and expose the inner volume of the portable case, the lid comprising foldable legs configured to extend to support the lid in an open position, a storage compartment for a plurality of replacement parts, and a thermally insulated storage compartment arranged to store a plurality of sample containers.

20. A fluid treatment method, comprising:
directing a fluid sample into a first filter disposed within a portable case, the first filter comprising a chamber defining an inner volume configured to receive the fluid sample;
pushing, with a piston disposed within the inner volume, the fluid sample along the chamber to filter the fluid sample;
directing the fluid sample from the first filter to a second filter fluidly coupled to the first filter to further filter the fluid sample; and
directing the fluid sample from the second filter to a sample container fluidly coupled to and configured to receive and store the fluid sample from the second filter.
